(19) United States
(12) Patent Application Publication
(10) Pub. No.: US 2002/0097249 A1
(43) Pub. Date: Jul. 25, 2002

(54) Method of and unit for processing an image

(76) Inventor: Luigi Agarossi, Concorezzo (IT)

Correspondence Address: Corporate Patent Counsel, U.S. Philips Corporation, 580 White Plains Road, Tarrytown, NY, 10591, US

(21) Appl. No.: 09/891,667

(22) Filed: Jun. 26, 2001

(30) Foreign Application Priority Data
Jun. 28, 2000 (EP) 00202235.8

(51) Int. Cl. G06F 3/14

(52) U.S. Cl. 345/629

(57) ABSTRACT

The processor (106) of an image processing unit (100) searches a received image for the presence of an original object of a predetermined appearance. If such an object is found, the processor (106) replaces the original object by a substitute object of a desired appearance. Subsequently, the image processing unit (100) outputs the modified image.

The invention relates to an image processing unit for processing an image, the image processing unit comprising an input for receiving the image, a processor for processing the image, the processor being arranged to substitute an original object residing at object coordinates in the image by a substitute object, and an output for outputting the processed image.

The invention further relates to an image display apparatus comprising such an image processing unit.

The invention further relates to a method of processing an image, the method comprising the steps of receiving the image, processing the image, including substituting an original object residing at object co-ordinates in the image by a substitute object, and outputting the processed image.

International Patent Application WO 97/40622 describes a system where a camera takes images of some sport event for reproduction on a television. In the sport events where this system is typically used, some moving object plays a central role. These are games like football, ice hockey, tennis and so on. Viewers watching the event on the television often have difficulties following the moving object and establishing its position in the game area. The known system has detectors around the game area that are able to determine the 3 dimensional position of the moving object. Furthermore, the system has controllers and detectors in the camera to determine what part of the area is viewed by the camera and of which the image is being taken. The system has a processing unit that receives the image from the camera and the 3 dimensional position from the detectors. Based on this information, the processing unit calculates the position in the image at which the moving object resides. Then the processing unit generates a synthetic substitute object that can replace the original moving object. By choosing the substitute object brighter or larger than the original object, the viewer watching the television can better see this object and can be more involved in the game.

It is an object of the invention to provide an image processing unit as described in the preamble with a more efficient substitution of the original moving object by a substitute object. This object of the invention is achieved according to the invention in an image processing unit that is characterized in that the processor is further arranged to search the image for the presence of the original object on the basis of a predetermined appearance and to determine the object co-ordinates of the original object, if present. The processing unit of the invention is capable of determining the original object's position in the image on the basis of the image itself. It does not require to receive the position information from an external source. This means that the complicated detector arrangement for detecting the position of the moving object in the game area, as used in the known system, can be dispensed with. This is highly advantageous because it saves time and effort for the installation of the detectors around the game area and it saves the costs for these detectors. Furthermore, the processing unit according to the invention is more flexible since it need not be decided in advance whether it will be applied for a certain sport event. If the sport event has been recorded, e.g. stored on the tape of a VCR, later reproduction on television may be done while using the processing unit of the invention.

An embodiment of the image processing unit according to the invention is described in claim 2. The processing unit then searches the image by trying to recognize the particular shape of the original object in the image. This is a relatively simple operation.

An embodiment of the image processing unit according to the invention is described in claim 3. With the selection unit of this embodiment, the user can effectively specify what object need to be replaced. Examples are: a football, a tennis ball, a golf ball and an ice hockey puck.

An embodiment of the image processing unit according to the invention is described in claim 4. With the selection unit of this embodiment, the user can effectively specify how the substitute object will look. This can be used, to let the user choose an object of a certain shape, or with a certain color, or of a certain brightness, and so on.

An embodiment of the image processing unit according to the invention is described in claim 6. In this embodiment, the processing unit searches a number of consecutive images for the presence of the original object. If it is found, then the positions of the original object in the respective images are compared with each other to determine whether they indeed relate to some real object. If the positions between two consecutive images were so drastically different that a real object could not have moved so much in the short time between images, this indicates an error in recognizing the original object. The determined positions will then be discarded and the original object will not be replaced by the substitute object. This makes the present embodiment robust against wrong interpretation of the images.

It is a further object of the invention to provide a method as described in the preamble in which the original moving object is substituted by a substitute object in a more efficient way. This object of the invention is achieved according to the invention in a method that is characterized in that the step of processing the image further includes searching the image for the presence of the original object on the basis of a predetermined appearance and determining the object co-ordinates of the original object, if present.

The invention and its attendant advantages will be further elucidated with the aid of exemplary embodiments and the accompanying schematic drawings, wherein:

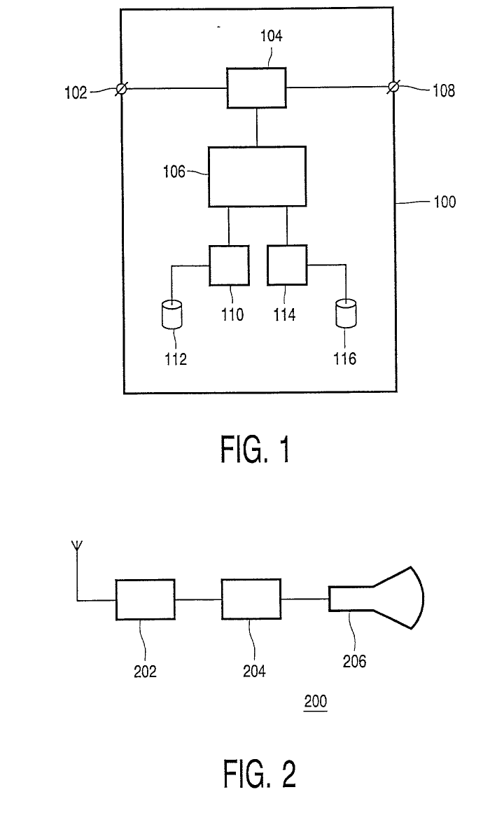

FIG. 1 schematically shows an image processing unit according to the invention, and

FIG. 2 shows the most important elements of an image display apparatus according to the invention.

Corresponding features in the various Figures are denoted by the same reference symbols.

FIG. 1 schematically shows an image processing unit according to the invention. The image processing unit 100 has an input 102 to receive an image to be processed. The received image is stored in an image memory 104. A processor 106 processes the stored image after which the potentially modified image is also available in the image memory 104. The processing may be organized such that only a single copy of the image is present in the memory, which copy is directly processed. Or the processing may be organized such that a new copy is created by copying and partially modifying the original copy. The latter procedure allows a complex processing in a simple way, but requires a memory that is large enough to accommodate two copies of the image. The new image is made available via output 108 of the image processing unit. Alternatively, the processor could directly operate on the image when it is received and transform it into an output image, without the image being stored. The image memory 104 is not necessary in that case.

The function of the processor is to replace a given object in the received image by a substitute object. This given object has a certain appearance which is specified in advance. The processor searches the image to find an object that meets the specified appearance. If such an object is found, its co-ordinates in the image are determined. In a simple form, the appearance is specified as a shape and the processor tries to find an object of such a shape in the image. In a more complex realization, the appearance includes a specific color, pattern or texture of the object. The techniques of finding an appearance in an image are known to the skilled person and are not further disclosed here. When the object has been found, it is replaced by a substitute object. This substitute object may be given the same size as the original object or it may be given a different size. This new size may be obtained by multiplying the original size by some magnification factor, e.g. 1.5. Furthermore, the substitute image may be given a greater brightness than the original object. Combining the created substitute object with the original to replace the original object is an operation that is known to the skilled person and not further disclosed here.

The processing unit 100 may contain an object selection unit 110 to allow the user to select the appearance of the object that must be replaced. A number of appearances are stored in a library 112, which may be a file in a storage medium of the processing unit. The user selects a particular appearance from the library by using means that are not further shown. These means may include a keyboard or a mouse to make a selection among a menu shown to the user. The processing unit 100 may further contain a substitute selection unit 114 to allow the user to indicate the substitute object that replaces the original object. A number of substitute objects are stored in a library 116, which may be a file in a storage medium of the processing unit. The user selects a particular substitute object from the library by using means that are not further shown. These means may include a keyboard or a mouse to make a selection among a menu shown to the user. The object selection unit 110 and the substitute selection unit 114 may be integrated into one selection unit allowing the selection of the original object and the substitute object. The user may then be offered choices for both objects in a menu from which the selection is made.

In an embodiment, the image processing unit is arranged to receive a series of consecutive images, e.g. the images of a movie, and the processor is able to operate fast enough to process each image in the pace of reception. In this way, the image processing unit can operate in real time on a video stream with images that are to be displayed on a television receiver. Depending on the standard of transmission, 25 or 30 full images must be processed per second. When such a series of consecutive images are received and processed, the processing unit may compare the results of different images with each other. If a desired original object is found at two different positions in two successive images. The processing unit can calculate the distance between the two positions and check whether the original object may indeed have moved over such a distance during the time period between the images. If this does not appear possible, an error has been made in the recognition of the original object in at least one of the image and there is not substitution of the original object by the substitute object. By comparing the results of two or more images and by not substituting the original object if recognition errors are suspected, erroneous substitutions are avoided thus making the image processing unit more reliable. The image processing unit may follow the position of the original object in a relatively large number of images, thus creating a track of the original object. The unit can then determine with a relatively large probability whether the positions are indeed from a track that could have been produced by a real object in the image. This again increases the reliability of the processing unit in this embodiment.

FIG. 2 shows the most important elements of an image display apparatus according to the invention. The image display apparatus 200 has a receiving means 202 for receiving a signal representing the images to be displayed. This signal may be a broadcast signal received via an antenna or cable but may also be a signal from a storage device like a VCR (Video Cassette Recorder) or a DVD (Digital Versatile Disk) player. The image display apparatus 200 further has an image processing unit 204 for processing the image and a display device 206 for displaying the processed image. The display device 206 is of a suitable type to display the images and can be a CRT (Cathode Ray Tube), an LCD (Liquid Crystal Display), PDP (Plasma Display Panel) or other type of display. The image display unit is implemented as described in connection with FIG. 1. A typical example of an image display apparatus 200 is a traditional television receiver.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The word ‘comprising’ does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the unit claims enumerating several means, several of these means can be embodied by one and the same item of hardware.

1. An image processing unit (100) for processing an image, the image processing unit comprising:
an input (102) for receiving the image,
a processor (106) for processing the image, the processor being arranged to substitute an original object residing at object co-ordinates in the image by a substitute object, and
an output (108) for outputting the processed image,
characterized in that the processor (106) is further arranged to search the image for the presence of the original object on the basis of a predetermined appearance and to determine the object co-ordinates of the original object, if present.

2. An image processing unit as claimed in claim 1, wherein the predetermined appearance is a shape.

3. An image processing unit (100) as claimed in claim 1, comprising a selection unit (110) to enable a user to select the predetermined appearance from a number of available appearances.

4. An image processing unit (100) as claimed in claim 1, comprising a selection unit (114) to enable a user to select the substitute object from a number of available objects.

5. An image processing unit (100) as claimed in claim 1, being arranged to receive a series of consecutive images and wherein the processor is arranged to process each of the images.

6. An image processing unit (100) as claimed in claim 5, wherein the processor (106) is arranged to determine a track of the original object over a number of the series of images and to decide to substitute the original object by the substitute only if such track can be determined.

7. An image display apparatus (200) comprising,
a receiver (202) for the reception of a signal representing an image,
an image processing unit (202, 100) as claimed in any of the claim 1 to 6, and
a display device (206) for displaying the processed image.

8. A method of processing an image, the method comprising the steps of
receiving the image,
processing the image, including substituting an original object residing at object co-ordinates in the image by a substitute object, and
outputting the processed image,
characterized in that the step of processing the image further includes searching the image for the presence of the original object on the basis of a predetermined appearance and determining the object co-ordinates of the original object, if present.
